(19) United States
(12) Patent Application Publication
(10) Pub. No.: US 2003/0002692 A1
(43) Pub. Date: Jan. 2, 2003

(54) Point sound masking system offering visual privacy

(76) Inventors: Mark A. McKitrick, Alto, MI (US); Kim A. Sena, Ada, MI (US)

Correspondence Address: Waters & Morse, P.C., 400 Ledyard Building, 125 Ottawa, Avenue, NW, Grand Rapids, MI, 49503, US

(21) Appl. No.: 10/159,555

(22) Filed: May 31, 2002

Related U.S. Application Data
(60) Provisional application No. 60/294,844, filed on May 31, 2001.

(51) Int. Cl. H04B 15/00

(52) U.S. Cl. 381/94.1

(57) ABSTRACT

A movable panel incorporating an at the point signal processor comprises a furniture screening panel mounted on a wheeled base and an electronic signal processor mounted to the panel. The processor receives a wireless electronic sound masking signal or other communication signal transmitted to the panel from a remote source and generates an audio or visual signal in a form that is perceptible in the vicinity of the panel. The transmitter has controls that are operable by a supervisor, while the receiver can be controlled by the user at the point of application. The multi-signal wireless receiver also can be incorporated in a door, artwork panel, keyboard tray, or other furniture component.

### CROSS-REFERENCES TO RELATED APPLICATIONS

This is a non-provisional application based on and claiming the filing priority of copending provisional patent application Serial No. 60/294,844, filed May 31, 2001, which is incorporated herein by reference.

### BACKGROUND OF THE INVENTION

The present invention relates generally to a sound masking system and more specifically it relates to an “at the point” sound masking system offering visual privacy for solving various problems in offices where open floor plans create a need for visual mobile privacy along with “at the point” sound control and voice and a data transmittal system for various applications including: dental and physician offices, open floor plan offices, conference centers, conference rooms and any open environment.

Sound masking systems have been in use for years. Typically, sound-masking systems are comprised of one of the following: (a) sound masking systems located in the ceilings, (b) office intercom systems, or (c) separate radio speakers.

There are several problems or drawbacks with conventional sound masking systems. Sound masking systems located in ceilings (a) do not provide masking at the point where it is needed, (b) are not movable or locally adjustable, (c) are expensive due to hard wiring, and (d) are difficult to service. Problems with conventional sound masking systems in office intercom systems are that such systems: (a) are not integrated with other communication devices, (b) are mostly hard wired systems needing strategic placement, (c) are unsightly aesthetically and lack space for the speakers, and (d) are not able to adjust for changing environments. Problems with conventional sound masking systems employing separate radio speakers include: (a)separate hard wiring of speakers is difficult to adjust for changing environments, (b) inability to easily relocate hard wired speakers, and (c) unsightly aesthetics and lack of space for the speakers. A general problem with all existing systems is the inability to integrate a number of features and provide broadcast of various signals in one system including: wireless sound masking, compact disc quality music, and interoffice communications, such as communications to broadcast meetings to offsite locations, through the utilization of NXT, infrared, and various wireless transmitters including: the 900 megahertz and new 32 bit gigahertz.

While conventional devices may be suitable for the particular purpose to which they are addressed, they are not as suitable for solving various problems in offices where open floor plans create a need for visual mobile privacy along with “at the point” sound control and transmittal of voice and data for various applications including.

### BRIEF SUMMARY OF THE INVENTION

In accordance with the present invention, a movable panel incorporating an at the point signal processor comprises a furniture screening panel having a face and a peripheral edge, the panel being mounted on a wheeled base that permits the panel to be rolled to different locations where screening is desired; and an electronic signal processor mounted to the panel, the processor receiving an electronic signal transmitted to the panel from a remote source and generating an audio or visual signal in a form that is perceptible in the vicinity of the panel.

In one aspect of the invention, the electronic signal is transmitted and received as a wireless signal. In another aspect of the invention, a single transmitter is used to transmit sound masking signals as well as other communication signals to receivers positioned at the point of application. The transmitter has controls that are operable by a supervisor, while the receiver can be controlled by the user at the point of application.

These and other features, objects, and benefits of the invention will be recognized by one having ordinary skill in the art and by those who practice the invention, from the specification, the claims, and the drawing figures.

### BRIEF DESCRIPTION OF THE SEVERAL VIEWS OF THE DRAWING

FIG. 1 is an exploded view of a movable screening panel of the present invention mounted on a wheeled base.

FIG. 2 is a front or face elevational view of the panel of FIG. 1.

FIG. 3 is a fragmentary view of a corner of the panel of FIG. 1, with a portion of the panel being broken away to show the interior thereof.

FIG. 4 is a schematic illustration of a wireless transmitter for transmitting sound masking and/or communication signals to the moveable panel.

FIG. 5 is a perspective view of a door panel constructed in accordance with the present invention.

FIG. 6 is a face or front elevational view of the door panel of FIG. 5, with the face panel thereof being shown partially broken away to show the interior of the door panel.

FIG. 7 is a perspective view of an artwork panel constructed in accordance with the present invention.

FIG. 8 is a front elevational view of the artwork panel of FIG. 7, with the face panel comprising the artwork being removed in order to show the interior of the panel.

FIG. 9 is a perspective pictorial view showing the wireless audio system of the present invention mounted in a keyboard drawer.

### DETAILED DESCRIPTION OF THE INVENTION

Referring to the drawings, a first embodiment of a movable panel 10 constructed in accordance with the present invention is shown in FIGS. 1-3. Panel 10 is a furniture screening panel 12 mounted on a wheeled base 14. Panel 12 comprises a frame 16 that extends around the periphery of the panel. Frame 16 can be formed of conventional construction materials, such as 1⅞ inches timber, tubular steel frame, formed steel, or plastic or composite material. The frame includes side members 18 and 20, a bottom rail 22, and a top rail 24. Top rail 24 has a U-shaped portion creating a recess 26 for a wireless receiver 28 (shown in FIG. 1). The panel includes spaced cross beams 30 and 32 defining a partially or completely open center section 34, an upper section 36 filled with door core material, and a lower section 38 also filled with door core material. Lower beam 22 includes fastener connections 40 for connecting arms 42 and 44 of base 14.

The center section 34 of the screening panel may have an open interior or it may be partially filled with door core or other sound deadening or strengthening materials and provided with recesses for the various components of the invention. The outer edges of the screening panel desirably are covered with 1⅞ inches PVC bumper molding or other appropriate material in order to prevent damage to other furniture that the panel may come in contact with.

The face of the panel can be covered with a number of different types of surface material. For example, the panel can be covered with fiberboard (which can be fabric covered), a marker board or a tackboard. Or the panel can be covered with a laminate. A number of other surface treatments can be employed. In one embodiment of the present invention, upper and lower sections 36 and 38 are covered with a normal decorative covering. Center section 34 is covered with an insert capable of accepting a tackboard, markerboard, liquid crystal monitor, speakers, or NXT transducer system. The insert, also called a face plate, also accepts various plug-in modules, including level 3 and level 5 MJ 85 jacks 55 to provide quick disconnect for computers.

As shown in FIG. 1, monitor 54 can fit in a monitor opening 56, and speakers or transducers 50 fit in openings 58. Transducers 50 desirably are NXT transducers. NXT transducers, in effect, supplant regular loudspeakers and convert the entire screening panel assembly into a speaker. This technology has the advantage of causing sound transmission from the surfaces of the panel on both sides of the panel. As an alternative, loudspeakers 52 can be employed in the present invention.

Appropriate wiring 60 interconnects these components with receiver 28. A rechargeable battery pack 62 is connected by wiring 64 to the receiver. The receiver can be operated by the rechargeable battery pack or it can be plugged into a conventional 110 outlet by plug-in wire assembly. Alternatively, the battery pack can be connected to a battery charger 66. The battery pack 62 provides eight hours of operation and is rechargeable by means of a low voltage recharger 66 which plugs into a conventional 110 volt outlet. The battery pack is easily removed for replacement or servicing. In the illustrated embodiment, the battery pack is mounted in the upper corner of the panel. The battery pack consists of several batteries connected together to achieve a nominal 9.5 volt power source. The battery pack sends power to the receiver and amplifier. A low voltage 9.5 volt recharger is included with the battery pack and desirably plugs into a jack 61 located in the lower corner of the panel. The charger provides quick recharge to the batteries through cable 63 and is easily unplugged from the panel as well as the wall. The 110 volt plug 65 has a unique stowaway compartment 67 that accepts both the cord and the plug. This allows the user to determine whether they desire to use only batteries, charge the batteries, or operate the unit on a standard 110 volt duplex receptacle. The battery pack is made of polyvinyl plastic and is encased in an extruded plastic channel.

The battery pack is designed to operate for a period of 8 hours before a recharge is required. The battery pack removes simply without tools for ease of maintenance and/or replacement. Various combinations of battery voltages may be utilized to achieve differing results. The 9.5 volts are utilized for peak performance, easy storage, and low voltage drain. Cases could be used out of metal and/or plastics.

The wheel assembly or base 14 of panel 10 comprises a pair of spaced arms 42 and 44 that extend laterally from both sides of the panel at opposite ends of the panel. The arms are formed of solid steel bar stock and are painted or plated and final coated with an expanded polyvinyl foam. Rubber or a soft durometer plastic or other cushioning material also can be used. The polyvinyl, which should cover at least the ends or tips of the legs, prevents the unit from tipping and from damaging furniture or walls that they may come in contact with. The arms of the wheel assembly preferably are manufactured from cold-rolled steel, desirably 3/4 inches in thickness, and are formed with a slight upward arc in the center to prevent accidental engagement with a hazard. Threaded inserts at the ends of the arms provide a mounting surface to affix the wheels. The heavy steel functions as a counter weight to help deter tipping of the panel. The lateral extension of the arms further impedes panel tipping. Caster wheels 70 are positioned at the outer ends of each leg. These casters are conventional. Preferably two standard casters and two locking casters are employed. The locking casters permit the panel to be fixed at a desired position.

Instead of manufacturing the wheel assembly out of solid steel bar stock, the wheel assembly can be manufactured from other suitable materials, such as formed steel of various thicknesses, with a counterweight separately placed in the panel. Also, the wheels could be welded instead of being affixed by threaded inserts. Various finishes can be utilized, such as chrome plating, E-coat plating, wet coat finishing, and various molded caps and covers.

The receiver 28 is made out of various battery-powered components that offer the least amount of voltage drain. A built in amplifier is integrated to boost signal volume. A light emitting diode 70 indicates the unit's operation status. The receiver slides out for easy repair and battery replacement. The receiver is a device that receives various signals including: voice, data, stereo quality music, mono quality music, and streaming video. The receiver includes an integrated amplifier that is powered either by battery and/or standard 110 volt electricity. The receiver includes a light emitting diode to locate the off/on position of the unit. A plunger style off/on device is also located within the receiver. A removable cover assist with the easy removal of the receiver to replace the battery and for repair and/or maintenance. The receiver is adapted to receive either a wireless of infrared signal. The receiver allows various degrees of adjustment to allow different channels to be fine tuned with the transmitter. The receiver can be constructed of molded PVC plastic or other suitable material. Multiple dipswitches allow the user to select different signals including voice, data, streaming video, stereo music, white noise, and intercom. The dipswitches are activated to pick up which channel the supervisor is transmitting. The receiver can also incorporate a transmitter in order to transmit voice, data, and intercom back to the transmitter. The secondary receiver operation allows the supervisor/conference attendee to communicate via a wireless connection. The receiver may utilize differing signal transfer rates and means of device selection including: infrared, wireless 900 megahertz, 32 megahertz, and other new technologies that allow for the transfer of data and voice components over the air ways. The receiver may be constructed of various plastics and/or metals.

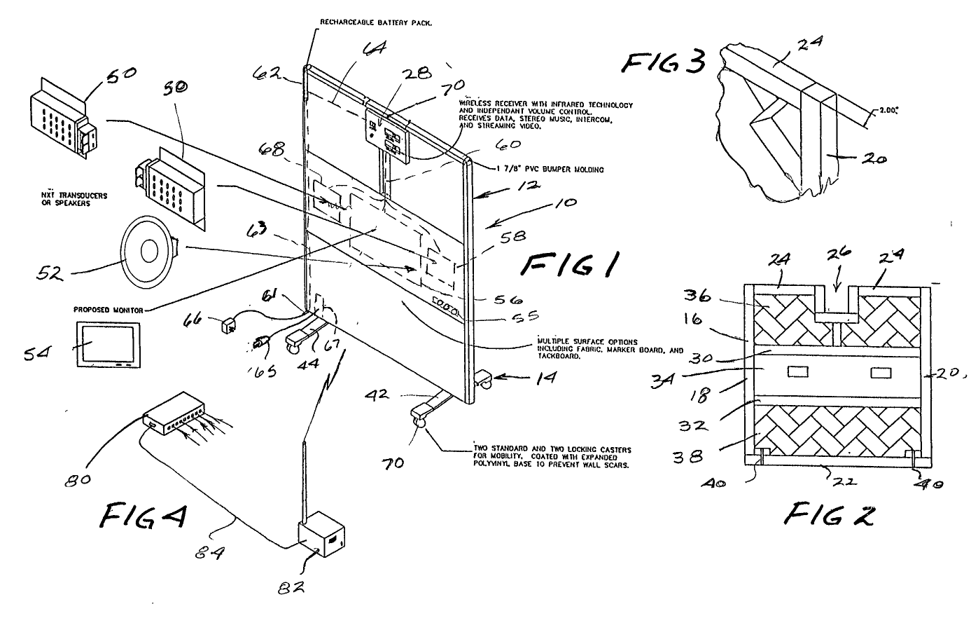

As shown in FIG. 4, signals are transmitted to the receiver from a control box 80 and transmitter 82, located remotely from the receiver. The control box receives input from various communication sources, including a sound masking white noise generator. The control box is connected to wireless transmitter 82 through cable 84. Multiple dipswitches in the control box allow for selection of the desired signals to be transmitted through the transmitter. For example, the unit will transmit compact disc quality music, white noise, streaming video, and intercom pick-ups and transmitters. These devices will allow a conference to broadcast to another room, another device, and to interact with each other. This offers a non-attendee of a conference to attend while being up to 150 feet away. The signals travel through walls and obstructions and allow clear communications. Furthermore, the dipswitch device will allow for multiple broadcast of different signals to singular or multiple receivers. The dipswitch device of control box 80 consists of several off and on switches, RCA input jacks and/or screws, clips or differing combinations in order to integrate differing devices. The switches allow the supervisor to choose what signal they wish to broadcast including: voice, data, streaming video, stereo music, white noise, and intercom. The multiple dipswitch device allows for hook up of an infrared repeater unit to allow selections to be made from a distance through an optional remote control. The control box dipswitch device may incorporate other methods for device selection including FM wireless remote controls. It may also be hooked up directly to the main transmitter/receiver 82.

The main transmitter 82 allows units to be operated off of one transmitter. The transmitter has a separate volume control to allow supervisor maximum volume control settings while still allowing users final adjustment. The unit may be locked in various cabinets, as the size does not exceed 8″×7″. The main transmitter also can include a secondary receiver unit. The main purpose of the transmitter unit is to transmit signals including: voice, data, white noise, stereo music, and intercom, while its secondary purpose is to receive voice and data back to the unit. The main transmitter secondary receiver has supervisor volume controls, an antenna, a 110 volt wall plug, and a battery to operate if needed without 110 voltage. The unit is easily secured in a supervisor's overhead compartment or drawer unit to prevent unauthorized transmitting of signals, and/or volume controls without approval. The secondary receiver operation allows the supervisor/conference attendee to communicate back and forth via a wireless connection. The transmitter can be manufactured from various plastics and/or metal.

The panel is attached to the wheel assembly that provides easy mobility. The main transmitter is connected only by airwaves to the receiver 28. The receiver likewise is connected back to the main transmitter through the airwaves. The main amplifier is attached to the receiver as well as the main battery pack, light emitting diode, and to the speakers and/or transducers. The speakers and/or transducers are attached to the faceplate of the insert covering center section 23, which desirably is a stiff fiberboard-like material. The faceplate in turn is attached to the panel. The wireless connection removes any restrictions on the placement or movement of the screening panel.

In operation, the supervisor activates the main transmitter. This produces a signal of voice, data, stereo music, white noise, or streaming video as selected by the supervisor. The user turns the main receiver to the on position until the light emitting diode is activated. The signal travels to the panel that has the main receiver located in it. The receiver receives the signal. The amplifier of the receiver is adjusted by the user through the use of the volume control. The amplifier, now adjusted to the desired volume strength, carries the signal by wires to the transducers and/or speakers that in turn allow the signal to be heard. The same is the case with data or video, only it is transmitted to the liquid crystal display. The receiver can be mounted by different attachment mechanisms to a number of things other than space divider panels, including doors, artwork, hanging units, and suspended units. The receiver and speakers are attached to the panel as a means to offer visual and/or divided space in addition to at the point audio or video communication. The wheel assembly provides mobility for the panel and the electronic equipment.

There are several uses for this invention. One is for a conference. The user simply wheels the panel into the area he desires. The supervisor then transmits a signal for the conference. The supervisor can attend the meeting without leaving his desk while the conference receives data, picks up the data, and provides a visual display. The supervisor can talk and/or hear the presentation and interact accordingly. Another example would be for a user who is working at a desk without walls or privacy and needs some either temporary or full time visual and noise screening. They would wheel the device to the desired location. The panel would provide the visual relief while the receiver would produce white noise sound masking. The white noise would be at the point of need and would allow for relief from others hearing the user's conversations. Another example would be a large conference center. The panels would be wheeled into place and generate audio output where needed. Secondary transmitters in the panels would permit audience feedback or participation or questions to a speaker without the need for separate microphones.

Another embodiment 100 of the present invention is shown in FIGS. 5 and 6. In this embodiment, panel 102 is a door having a frame 104 and a surface panel 106 on both sides of the door. The door has multiple interior compartments, as in the previous embodiment, with an upper 20 compartment 108 including door core material for strengthening, and a lower compartment 110 including door core material for strengthening. A central compartment 112 can be completely or partially open and covered with a face plate 114. NXT transducers 50 are shown for exemplary purposes mounted in a central compartment 112. The door has a recess 116 in an upper edge, and a receiver 118, shown schematically in FIG. 5, slides into recess 116 in a manner similar to the previous embodiment.

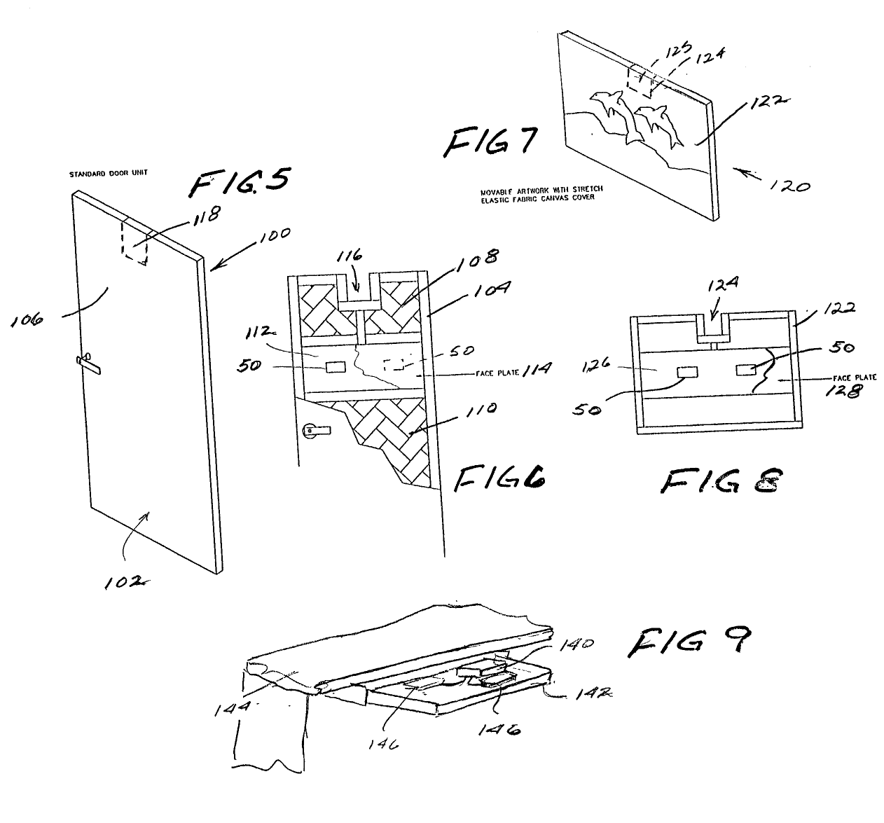

In another embodiment of the present invention, shown in FIGS. 7 and 8, an artwork panel 120 includes a frame 122 having a similar configuration to the prior embodiments, with a recess 124 for a receiver 125 in the upper edge of the panel. The panel includes an open center section 126 covered by a face plate 128, concealing exemplary transducers 50. The face or front surface of the artwork is covered by artwork, such as a decorated stretch elastic fabric canvas cover. The artwork is mounted on a wall by a conventional wall hanging device and transmits signals to the room in which the artwork is mounted. The artwork can be moved to any other location as may be desired.

The sound transmission system of the present invention, wherein a single transmitter connected to multiple sources of input signals, including sound masking signals, are transmitted to individual receivers at the points of use by a wireless transmission system can be employed in a number of different ways, in addition to the movable panels as described above. For example, in FIG. 9, a receiver 140 is shown in schematic form mounted in a keyboard tray 142 on the underside of a work surface 144. Speakers or transducers 146 can be mounted on any rigid or semi-rigid surface, such as the keyboard tray itself, or on the work surface, so that a wireless signal directed to the receiver will be received in the computer keyboard tray of an operator's work station. The advantage of all of these systems is that the receivers can be placed where desired and moved to new locations without requiring modification of wiring, and in each case, both the supervisor and individual operator have control over the signal received at the operator's work location. Moreover, sound masking as well as other communication signals and background music and the like can be transmitted through the same system.

It should be understood that various modification and changes may be made in the arrangements and details of construction of the embodiments disclosed herein without departing from the spirit and cope of the present invention, as defined in the attached claims.

I claim:

1. A movable panel that provides audio as well as visual screening in a single movable module, the panel having a face and an edge and means for positioning the panel at different locations, the panel also including a receiver capable of receiving a sound masking signal in electronic form and producing a corresponding audible output signal from the panel that is detectable in the vicinity of the panel, the receiver output being adjustable at the panel.

2. A movable panel as in claim 1 wherein the panel employs NXT technology to produce the audible output, wherein a transducer causes the panel itself to produce an audible signal.

3. A movable panel as in claim 1 wherein the receiver is adapted to receive a wireless signal from a remote source, such that panel position is not restricted by necessary wire connections.

4. A movable panel as in claim 1 wherein the panel comprises a furniture screening panel mounted on a wheeled base that permits the panel to be rolled to a desired location.

5. A movable panel as in claim 1 wherein the panel comprises a decorative face panel that serves as artwork, the panel including mounting means for mounting the panel in a desired location on a wall.

6. A movable panel as in claim 1 wherein the panel comprises a door that is movably mounted to a door frame.

7. A movable screening panel incorporating an at the point signal processor comprising:
a furniture screening panel having a face and a peripheral edge, the panel being mounted on a wheeled base that permits the panel to be rolled to different locations where screening is desired; and
an electronic signal processor mounted to the panel, the processor receiving an electronic signal transmitted to the panel from a remote source and generating an audio or visual signal in a form that is perceptible in the vicinity of the panel.

8. A movable sound masking and communications system for an office environment comprising:
a white noise sound masking signal generator;
a wireless transmitter that transmits the sound masking signal as a wireless signal;
at least one movable screening panel that can be selectively positioned in a desired location;
a signal processor mounted to the panel for receiving the wireless signal from the transmitter and generating an audible output signal in the vicinity of the panel that is representative thereof; and
individual control means at the panel for adjusting the audible output signal.

9. A system as in claim 8 wherein the transmitter transmits other communications signals in addition to a sound masking signal, the signal processor being capable of receiving and producing output signals for the other communications signals as well.

10. A system as in claim 9 wherein the signal processor includes a video display and the other communication signals include a video signal.

11. A system as in claim 11 wherein the signal processor includes a receiver capable of receiving a music signal from a broadcast media or from a sound recording player.
